(19) United States
(12) Patent Application Publication
(10) Pub. No.: US 2006/0000107 A1
(43) Pub. Date: Jan. 5, 2006

(54) Dryer device

(76) Inventor: Arun M. Wylie, Malibu, CA (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 11/077,544

(22) Filed: Mar. 10, 2005

Related U.S. Application Data
(60) Provisional application No. 60/521,202, filed on Mar. 10, 2004.

(51) Int. Cl. F26B 19/00; F26B 21/06

(52) U.S. Cl. 34/80; 34/60

(57) ABSTRACT

The invention described herein includes a dryer device comprising: a flexible main body comprising one or more flexible sheets, wherein the main body defines a plurality of slits; and a static eliminating patch portion of the main body.

### RELATED APPLICATIONS

This application claims priority under 35 U.S.C. § 119(e) of U.S. Provisional Application No. 60/521,202, filed Mar. 10, 2004, which application is incorporated herein by reference.

### TECHNICAL FIELD

The present invention relates to a dryer device for use with a clothes dryer.

### BRIEF DESCRIPTION OF THE DRAWINGS

FIG. 1 is a perspective view of one embodiment of the dryer device.

### DETAILED DESCRIPTION OF THE INVENTION

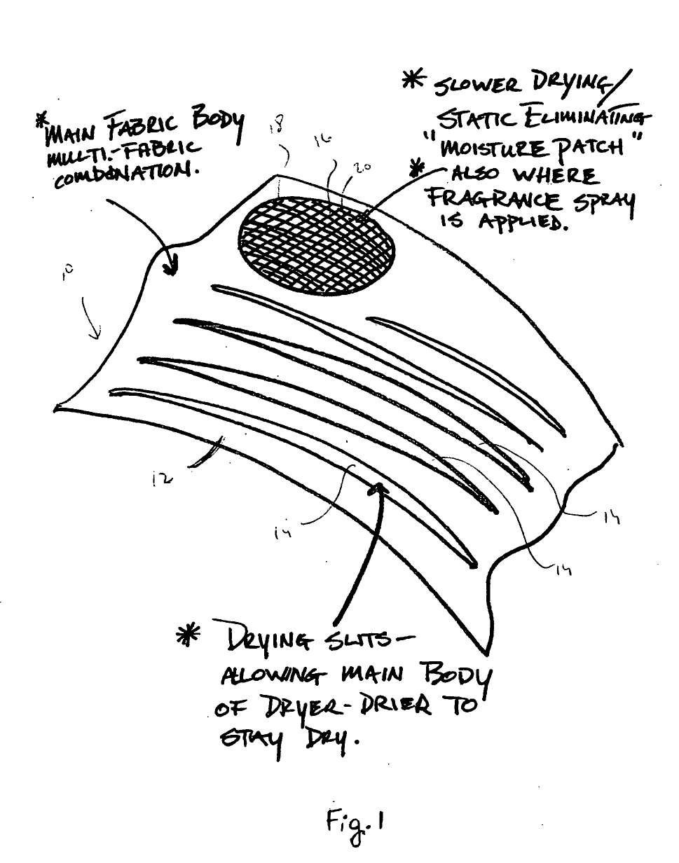

The dryer device of the invention described herein at 10 in FIG. 1, reduces time for clothing drying in a dryer, saves energy, reduces wear and tear on clothing and fabric, reduces static cling, is reusable and is capable of being recycled. The dryer device is also environmentally friendly.

For one embodiment, the dryer device, illustrated at 10 in FIG. 1, includes a flexible main body 12 with slits 14 and a moisture patch 16. In one embodiment, the flexible main body includes multi-fabric layering for absorbency and static elimination. The slits 14 in the main body allow for the flow of heat and air from a clothes dryer. For one embodiment, the dryer device 10 has a size of about 18 inches by 28 inches. For some embodiments, the dryer device 10 is about one inch thick. While a rectangular shape is shown, it is understood that the dryer device 10 may have a round shape, triangular shape, or any other conventional shape.

For some embodiments, the moisture patch 16 includes a mesh covering 18 that covers a chamber 20 defined by the main body 12. For some embodiments, the chamber 20 includes foam for retaining water, and, for some embodiments, other anti-cling materials. The chamber 20 and mesh covering 18 of the moisture patch 16 encloses and retains water. For some embodiments, the moisture patch 16 additionally retains fragrance. For some embodiments, the moisture patch 16 retains a material inhibiting static cling. The moisture patch 16 allows a natural fragrance spray option and helps to further reduce static by staying moist.

The dryer device 10 may be safely used repetitively. For some embodiments, the dryer device may be reused for up to about 300 loads of laundry. When the need for the use of the dryer device 10 is no longer desired it may be placed in storage or simply placed in a pocket or handbag. The dryer device 10 does not employ any aerosols, vapors or chemicals of any kind.

The dryer device 10 lowers energy costs by reducing drying time and saves wear and tear of clothing and fabrics. The dryer device also conserves energy by reducing drying time. The dryer device eliminates a need for chemical static cling reducers although the reducers are usable for some embodiments.

In operation, the dryer device is added to a load of clothing in a clothes dryer. When the dryer is operated, the dryer device 10 absorbs moisture from clothing in the dryer and releases the moisture through the drying slits 14. Once the clothing dries in the dryer, the moisture patch 16 releases water, and for some embodiments, fragrance, to prevent static cling in the dried clothing. Thus, the dryer device acts as both a drying agent and an anti-cling agent without releasing chemicals other than water and, optionally, fragrance into the clothing in the dryer.

While the invention has been described with a certain degree of particularity, it is manifest that many changes may be made in the details of the construction without departing from the spirit and scope of this disclosure. It is understood that the invention is not limited to the embodiments sent forth herein for purpose of exemplification, but is to be limited only by the scope of the attached claim or claims, including the full range of equivalency to which each element thereof is entitled.

What is claimed is:

1. A dryer device comprising: a flexible main body comprising one or more flexible sheets, wherein the main body defines a plurality of slits; and a static eliminating patch portion of the main body.

2. The dryer device of claim 1 wherein the patch portion includes a fragrance.

3. The dryer device of claim 1 wherein the patch portion includes a static eliminator.

4. The dryer device of claim 1, wherein the main body comprises multiple layers of flexible sheets.

5. The dryer device of claim 4 wherein the flexible sheets are water absorbent.

6. The dryer device of claim 1 wherein the static eliminating patch portion includes a foamed material.

7. The dryer device of claim 1, further comprising water in the static eliminating patch portion.

8. A method for drying clothing with an energy savings in a dryer, comprising:
providing the dryer device of claim 7; and
adding the device to the dryer.
